(19) United States
(12) Patent Application Publication
(10) Pub. No.: US 2019/0333270 A1
(43) Pub. Date: Oct. 31, 2019

(54) METHOD AND PROGRAM FOR CALCULATING STIFFNESS COEFFICIENT OF BRIDGE BY USING AMBIENT VIBRATION TEST DATA

(71) Applicant: Do Been KIM, Seoul (KR)

(72) Inventor: Do Been KIM, Seoul (KR)

(21) Appl. No.: 16/362,797

(22) Filed: Mar. 25, 2019

(30) Foreign Application Priority Data
Apr. 30, 2018 (KR) 10-2018-0050145

(51) Int. Cl. G06T 17/20; G06F 17/50; G06F 17/11; E01D 19/00

(52) U.S. Cl. CPC G06T 17/20; E01D 19/00; G06F 17/11; G06F 17/5018

(57) ABSTRACT

Disclosed herein are a method and program for calculating the stiffness coefficient of a bridge by using a finite element model. The method of calculating the stiffness coefficient of a bridge by using a finite element model includes: step (a) of receiving the information of a bridge in an ambient vibration test via a simulator for a finite element model; step (b) of calculating relative girder displacements (RGDs) by converting the deflection displacements of the bridge into proportions; and step (c) of calculating the stiffness coefficient k of the bridge from the error function of the bridge using the relative girder displacements (RGDs) as a variable by taking into account the deflection shape of the bridge in the relative girder displacements (RGDs) calculated at step (b). In this case, the stiffness coefficient k of the bridge is calculated using ambient vibration test data.

### CROSS-REFERENCE TO RELATED APPLICATION

This application claims the benefit of Korean Patent Application No. 10-2018-0050145 filed on Apr. 30, 2018, which is hereby incorporated by reference herein in its entirety.

### BACKGROUND

### 1. Technical Field

The present invention relates generally to a method and program for calculating the stiffness coefficient of a bridge, which are capable of calculating the stiffness coefficient of a bridge not only using data from static and dynamic load test but also ambient vibration data.

### 2. Description of the Related Art

In the fields in which the structural mechanics analysis of objects is researched intensively, such as the mechanical or structural engineering field, a finite element model, which is one of the approximation numerical analysis techniques for differential equations, is utilized. The finite element model may be applied to a wide range of fields, such as the strength deformation analysis of machines and structures, fluid flow analysis, electromagnetic field analysis, etc.

In particular, large-sized structures, such as bridges requiring safety, require structural analysis based on accurate load analysis. In the finite element model, the area of a corresponding structure to be analyzed is divided into predetermined unit volumes or areas, i.e., elements, which is called “meshing.” Particularly, for the structural analysis of a three-dimensional model composed of a plate structure, a finite element model is generated by dividing a region, formed by the three-dimensional model, into a plurality of small elements called shell elements.

In general, in the case of a finite element model used for bridge performance evaluation, the measured displacement data, which is the most valuable data for updating structural stiffness, of a bridge is acquired via a static vehicle load test in which the traffic of the bridge is controlled and then a vehicle is placed on the bridge, and then a stiffness coefficient is calculated. In other words, conventionally, the natural frequency and static displacement of a bridge have been incorporated into evaluation of structural performance. However, when the needs of a site are considered, it is desirable to evaluate the stability of a bridge based on ambient vibration test data that can be measured without traffic control.

In this regard, the present applicant presented the research paper “Improvement of Finite Element Model Using Relative Girder Displacement (RGD) and Evaluation of Rating Factor” at 2014 Regular Academic Conference of the Korean Society of Civil Engineers. In this research paper, the present applicant proposed a finite element model improved by introducing the concept “relative girder displacement (RGD)” in order to evaluate the rating factor of a bridge based on ambient vibration test data that can be measured without traffic control.

Although the concept “relative girder displacement (RGD)” will be described in greater detail in the following detailed description of the invention, this is a term that is obtained by defining displacements, generated in respective girders of a bridge, as proportions. Accordingly, the relative girder displacements (RGD) defined as proportions become a variable incorporating girder characteristics thereinto even in an ambient vibration test in which the magnitude of a load varies in real time, as in a static test. However, the relative girder displacements (RGDs) disclosed in the research paper are used to define an error function as the proportions of displacements generated in girders and to calculate a stiffness coefficient. In this case, the fact that the cases of the measured displacements (scalar values) of actual girders that satisfy the calculated stiffness coefficient are various is not taken into account.

In summary, although the research paper presents a method of improving the finite element model in order to calculate the stiffness coefficient of the girders based on even dynamic test data, a limitation arises in that the actually measured shapes of girders are not accurately taken into account because the shapes of girders satisfying the calculated stiffness coefficient are various.

Therefore, the present applicant has conceived a method and program for calculating the stiffness coefficient of a bridge as a scheme for an improved finite element model, which can calculate the stiffness coefficient of a bridge in an ambient vibration test in the state in which the bridge is open without requiring a static load test in which the bridge is controlled and then a load test is conducted in order to evaluate the stability of the bridge, and in which the shape of the bridge, i.e., the actually measured displacements of the bridge, are taken into account.

### SUMMARY

An object of the present invention is to provide a method and program for calculating the stiffness coefficient of a bridge, which calculate a stiffness coefficient for the evaluation of the stability of a bridge based on ambient vibration test data that can be measured without traffic control by using a finite element model improved to incorporate dynamic characteristics thereinto.

Another object of the present invention is to provide a method and program for calculating the stiffness coefficient of a bridge, into which a relative girder displacement (RGD) configured to incorporate static characteristics into the analysis of ambient vibration test data is introduced and in which a finite element model is improved to take into account a shape, i.e., the actually measured displacements of a bridge.

In order to accomplish any of the above objects, the present invention provides a method of calculating the stiffness coefficient of a bridge by using a finite element model, the method including: step (a) of receiving the information of a bridge in an ambient vibration test via a simulator for a finite element model; step (b) of calculating relative girder displacements (RGDs) by converting the measured displacements of the bridge into proportions; and step (c) of calculating the stiffness coefficient k of the bridge from the error function of the bridge using the relative girder displacements (RGDs) as a variable by taking into account the deflection shape of the bridge in the relative girder displacements (RGDs) calculated at step (b); wherein the stiffness coefficient k of the bridge is calculated using ambient vibration test data.

Step (a) may include receiving data on displacements generated by the girders of the bridge during ambient vibration as the information of the bridge via the simulator for a finite element model.

At step (b), each of the relative girder displacements (RGDs) may be defined as a value obtained by dividing a displacement value generated in each of the girders by the displacement value of the girder having the largest one of displacement values generated in the respective girders of the bridge in an ambient vibration test, and the relative girder displacement (RGD) may be represented by Equation 1 below:

$${RGD}_{i} = \frac{{δ}_{i}}{max ( {δ}_{i} )} \qquad ( 1 )$$

where RGD is the relative girder displacement, δ is the displacement value, i is the grid number of each of the girder, and max(δ) is the displacement value of the girder having the largest one of the generated displacements.

At step (b), each of the relative girder displacements (RGDs) may be defined as a value obtained by dividing the displacement value generated in each of the girders by the sum of the displacement values generated in the girders of the bridge in an ambient vibration test, and the relative girder displacement may be defined as Equation 2 below:

$${RGD}_{i , sum} = \frac{{δ}_{i}}{{\sum }_{i = 1}^{N} {δ}_{i}} \qquad ( 2 )$$

where RGD is the relative girder displacement, δ is the displacement value, i is the grid number of the each of the girder, and Σᵢ₌₁^{N}δᵢ is the sum of the displacement values generated in the respective girders.

Step (b) may enable the calculation of the stiffness coefficient independent of a magnitude of the load applied to the bridge in such a manner that the relative girder displacements (RGDs) convert the deflection displacements of the individual girders of the bridge into proportions.

Step (b) may include: step (b-1) of defining the relative girder displacements (RGDs); step (b-2) of defining the error function of the relative girder displacements (RGDs) each obtained by dividing the difference between the simulated value of the relative girder displacement (RGD) and the actually measured value of the relative girder displacement (RGD) by the actually measured value of the relative girder displacement (RGD); and step (b-3) of calculating the relative girder displacements (RGDs) when the error function of the relative girder displacements (RGDs) defined at step (b-2) is minimized.

The error function of the relative girder displacement (RGD) at step (b-2) may be defined by Equation 3 below:

$${e ( x )}_{RGD} = \frac{1}{M} {\sum }_{i = 1}^{M} {( \frac{{RGD ( x )}_{i}^{a} - {RGD}_{i}^{m}}{{RGD}_{i}^{m}} )}^{2} \qquad ( 3 )$$

where e(x)_{RGD} is the error function of the relative girder displacements (RGDs), RGD(x)ᵢ^{a} is the simulated value of the relative girder displacement (RGD) that is variable in the simulator for a finite element model, and RGDᵢ^{m} is the actually measured value of the relative girder displacement (RGD).

Step (c) may include step (c-1) of defining a relative girder displacement assurance criterion (RGDAC) as the outer product of the actually measured vector of the relative girder displacement (RGD) and the simulated vector of the relative girder displacement (RGD); and the deflection shape of the bridge may be taken into account by correcting the relative girder displacements (RGDs) represented by individual values.

Step (c) may include step (c-2) of defining the error function of the bridge by using the relative girder displacement assurance criterion (RGDAC), as shown in Equation 4 below:

e2(x)_{RGDAC}=|1−RGDAC| (4)

where RGDAC is a relative girder displacement assurance criterion, and e2(x)_{RGDAC} is the error function of the bridge; and the stiffness coefficient k may be calculated based on the relative girder displacement assurance criterion (RGDAC) when the error function of the bridge is minimized.

In order to accomplish any of the above objects, the present invention provides a computer-readable storage medium having stored therein a program for calculating the stiffness coefficient of a bridge by using a finite element model that, when executed by a computer, causes the computer to perform: step (a) of receiving the information of a bridge in an ambient vibration test via a simulator for a finite element model; step (b) of calculating relative girder displacements (RGDs) by converting the measured displacements of the bridge into proportions; and step (c) of calculating the stiffness coefficient k of the bridge from the error function of the bridge using the relative girder displacements (RGDs) as a variable by taking into account the deflection shape of the bridge in the relative girder displacements (RGDs) calculated at step (b).

### BRIEF DESCRIPTION OF THE DRAWINGS

The above and other objects, features, and advantages of the present invention will be more clearly understood from the following detailed description taken in conjunction with the accompanying drawings, in which:

FIG. 1 shows the individual steps of a method of calculating the stiffness coefficient of a bridge according to an embodiment of the present invention;

FIG. 2 shows a conceptual diagram of the finite element model for calculating a stiffness coefficient through a test on the rating factor of a bridge;

FIG. 3 shows the step of calculating a relative girder displacement (RGD) according to an embodiment of the present invention;

FIG. 4 shows the step of calculating the stiffness coefficient of a bridge according to an embodiment of the present invention;

FIG. 5 shows the relative girder displacements (RGDs) of various shapes having minimum error values in an error function based on Equation 3;

FIG. 6 shows a test example in which the stiffness coefficient of a bridge is calculated, which shows a case where an ambient vibration load is applied to some girder of the bridge; and

FIG. 7 is a graph showing the comparisons among the deflection displacements of girders actually measured as the results of the test examples of FIG. 6, the deflection displacements of girders obtained using the conventional method, and the deflection displacements of girders obtained using the method of calculating a stiffness coefficient according to an embodiment of the present invention.

### DETAILED DESCRIPTION

The present invention will be described in detail below with reference to the accompanying drawings. However, the present invention is not limited or restricted to exemplary embodiments. The same reference symbols that are presented in the individual drawings denote the members that perform substantially the same function.

The objects and effects of the present invention will be naturally understood or made clearer by the following description, and the objects and effects of the present invention are not limited merely by the following description. Furthermore, in the following description of the present invention, when it is determined that a detailed description of a well-known technology related to the present invention may unnecessarily make the gist of the present invention obscure, the detailed description will be omitted.

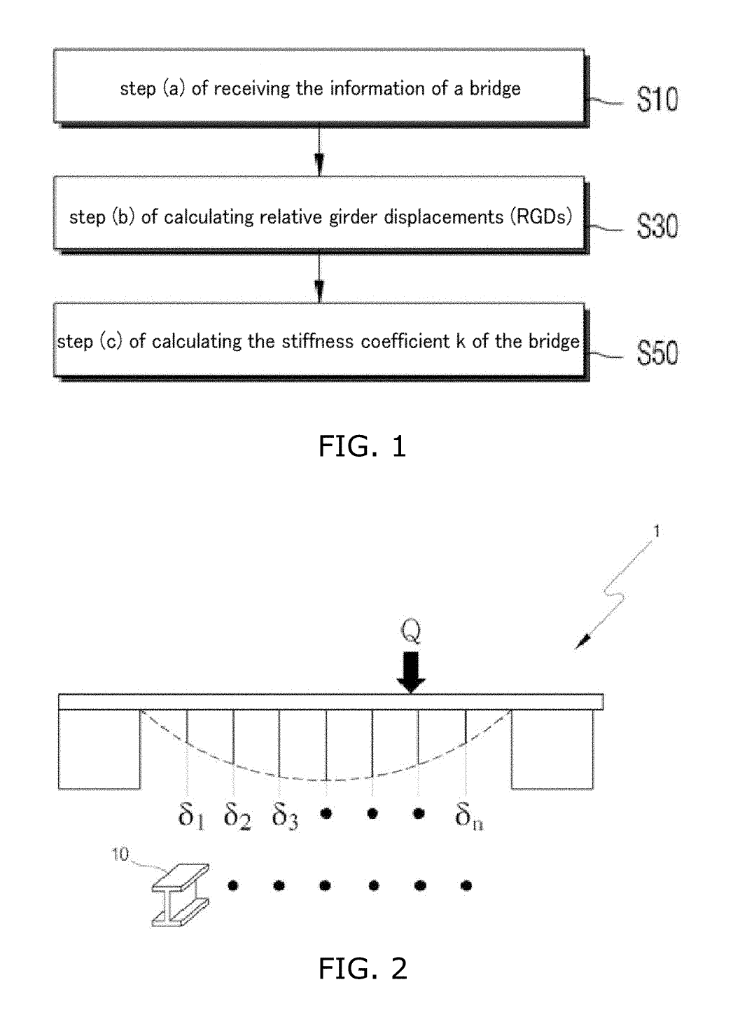

FIG. 1 shows the individual steps of a method of calculating the stiffness coefficient of a bridge according to an embodiment of the present invention. Referring to FIG. 1, the method of calculating the stiffness coefficient of a bridge according to the present embodiment may include step (a) S10 of receiving the information of a bridge, step (b) S30 of calculating relative girder displacements (RGDs), and step (c) S50 of calculating the stiffness coefficient k of the bridge. The method of calculating the stiffness coefficient of a bridge according to the present embodiment may calculate the stiffness coefficient of a bridge by using ambient vibration test data.

FIG. 2 shows a conceptual diagram of a finite element model for calculating a stiffness coefficient k via a test on the rating factor of a bridge 1. Referring to FIG. 2, the stability of the bridge 1 may be evaluated by calculating the stiffness coefficients k of girders 10. The external force F applied to the bridge 1 may be presented by the product of a stiffness coefficient k and a displacement x. Referring to FIG. 2, when a load Q is applied to the bridge 1, the deflections of the girders 10 occur. When the deflections of the girders 10 are set to displacements δ, the relation Q=k·δ is established. In the evaluation of the stability of the bridge 1, the stiffness coefficients k are calculated by measuring the deflection displacements δ of the girders 10 by applying the load Q to the bridge 1.

As illustrated in FIG. 2, the finite element model refers to a model in which the individual girders 10 of the bridge 1 are composed of computers and finite elements that are internally connected to each other. Generally, the evaluation of the rating factor of the bridge 1 is performed by analyzing displacements generated in the respective girders 10 by means of the relation “Q=k·δ” via a static load test in which a load Q is applied to a bridge in the state in which the bridge has been controlled. In this case, the error function of the bridge 1 by which the conventional finite element model calculates k is set, as follows:

<Error Function in Static Load Test>

$$e = \frac{{δ}^{a} - {δ}^{m}}{{δ}^{m}}$$

where e is an error function, δ^{m} is the deflection of the girder 10 actually measured in a static load test, and δa is the deflection of the girder 10 simulated in a finite element model. In other words, the actually measured value δm of the girder is substituted into the error function. The moment at which the value of the error function e is minimized is searched for while varying the value δa in the finite element model. In this case, the stiffness coefficient k is calculated via the displacement δ calculated using the relation Q=k·δ and already known value of the load Q. However, a problem arises in that in the state in which the bridge has not been controlled, the magnitude and location of the load Q vary in real time, and thus the stiffness coefficient k may not be calculated using the conventional finite element model.

Therefore, an embodiment of the present invention proposes a finite element modeling method that has been improved to obtain a result, such as the result of the calculation of the stiffness coefficient in a static load test, by using ambient vibration test data in which the load is variable in real time without depending upon the magnitude of the load.

Step (a) S10 refers to the step of receiving the information of the bridge under an ambient vibration test via a simulator for a finite element model. At step (A) S10, data on displacements that are generated when the girders 10 of the bridge 1 are subjected to ambient vibration may be received as the information of the bridge via the simulator for a finite element model. In the present specification, the term “bridge 1” is defined as a term including the girders 10 of the bridge 1. Accordingly, the calculation of the stiffness coefficient of the bridge 1 may be understood as the calculation of the stiffness coefficients of the plurality of girders 10.

Step (a) S10 refers to the step of receiving the values on of the deflections of the girders 10 in an ambient vibration test. In the present embodiment, step (a) S10 may be understood as the step at which a user enters ambient vibration test data on a website that is constructed by a server in which the computation of the finite element model is performed. The displacement values entered by the user at step (a) S10 are actually measured test data values. In the following, the value of an actually measured displacement is denoted by δm, and a model value used to simulate the point, at which an error function is minimized, in order to calculate a stiffness coefficient is denoted by δa.

Step (b) S30 refers to the step of calculating relative girder displacements (RGDs) by converting the deflection displacements of the bridge 1 into proportions. Step (b) S30 enables the calculation of the stiffness coefficient independent of the magnitude of the load applied to the bridge in such a manner that the relative girder displacements (RGDs) convert the deflection displacements of the individual girders 10 of the bridge 1 into proportions. The present applicant defined the concept “relative girder displacement (RGD)” in order to incorporate static characteristics into the calculation of a stiffness coefficient in an ambient vibration test. Accordingly, the present applicant presented the paper regarding an improved finite element model (Do-bin Kim and three other persons, “Improvement of Finite Element Model Using Relative Girder Displacement (RGD) and Evaluation of Rating Factor,” 2014 Regular Academic Conference of the Korean Society of Civil Engineers).

In the method of calculating a stiffness coefficient according to the present embodiment, in order to further improve the finite element model improved by means of the relative girder displacement (RGD), a variable called “a relative girder displacement assurance criterion (RGDAC)” is used. To help the understanding of an embodiment to be described later, the term “relative girder displacement” will now be described. The relative girder displacement is abbreviated to “RGD.”

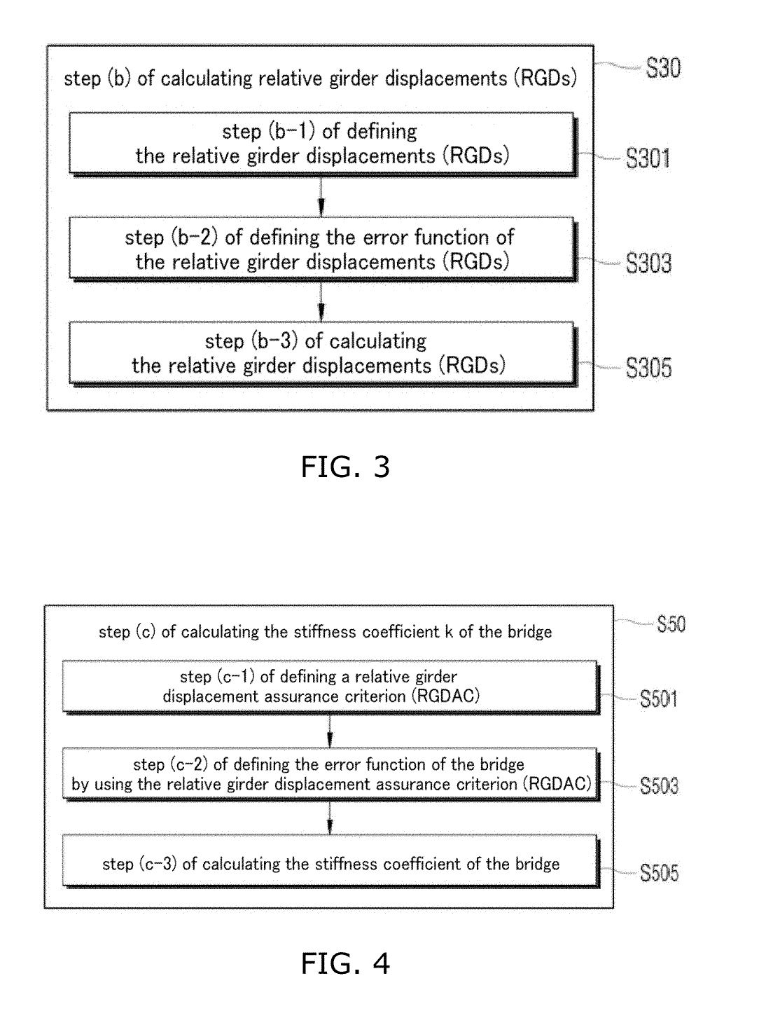

FIG. 3 shows the step of calculating relative girder displacements (RGDs) according to an embodiment of the present invention. Referring to FIG. 3, step (b) S30 may include step (b-1) S301 of defining relative girder displacements (RGDs), step (b-2) S303 of defining the error function of the relative girder displacements (RGDs), and step (b-3) S305 of calculating the relative girder displacements (RGDs).

Step (b-1) S301 refers to the step of defining the relative girder displacements (RGDs). The relative girder displacements are a variable that was developed by the present applicant in order to incorporate the static characteristics of a bridge in an ambient vibration test in which the bridge was not controlled. In an ambient vibration test, as the magnitude of a load Q varies continuously, the scalar value of the deflection displacement δ of the girder 10 also varies continuously. In this case, the characteristics of the girders 10 are constant both in a static load test and in a dynamic load test. Accordingly, when the scalar values of the displacements δ are represented by proportion values representative of the displacement characteristics of the individual girders 10, this is independent of the magnitude characteristics of the load, and static characteristics related to the stiffness coefficients of the girders 10 may be taken into account.

At step (b-1) S301, each of the relative girder displacements (RGDs) may be defined as a value obtained by dividing a displacement value generated in each of the girders by the displacement value of the girder 10 having the largest one of displacement values generated in the respective girders 10 of the bridge 1 in an ambient vibration test, and the relative girder displacement (RGD) may be represented by Equation 1 below:

$${RGD}_{i} = \frac{{δ}_{i}}{max ( {δ}_{i} )} \qquad ( 1 )$$

where RGD is the relative girder displacement, δ is the displacement value, i is the grid number of the each of the girder, and max(δ) is the displacement value of the girder having the largest one of the generated displacements.

As another embodiment, at step (b-1) S301, each of the relative girder displacements (RGDs) may be defined as a value obtained by dividing the displacement value generated in each of the girders 10 by the sum of the displacement values generated in the girders 10 of the bridge 1 in an ambient vibration test, and the relative girder displacement may be defined as Equation 2 below:

$${RGD}_{i , sum} = \frac{{δ}_{i}}{{\sum }_{i = 1}^{N} {δ}_{i}} \qquad ( 2 )$$

where RGD is the relative girder displacement, δ is the displacement value, i is the grid number of the each of the girder, and Σᵢ₌₁^{N}δᵢ is the sum of the displacement values generated in the respective girders.

In summary, at step (b-1) S301, it is sufficient if the relative girder displacement (RGD) defines the characteristic of the girder 10 as a proportion. In this case, the proportion may be defined as a value obtained by dividing the displacement value of each of the girders 10 by the largest displacement value, i.e., the value of max(δ), or by dividing the displacement value of each of the girders 10 by the sum of the displacement values of all the girders 10.

Step (b-2) S303 refers to the step of defining the error function of the relative girder displacements (RGD) each obtained by dividing the difference between the simulated value of the relative girder displacement (RGD) and the actually measured value of the relative girder displacement (RGD) by the actually measured value of the relative girder displacement (RGD).

At step (b-2) S303, the error function of the relative girder displacements (RGDs) may be defined as Equation 3 below:

$${e ( x )}_{RGD} = \frac{1}{M} {\sum }_{i = 1}^{M} {( \frac{{RGD ( x )}_{i}^{a} - {RGD}_{i}^{m}}{{RGD}_{i}^{m}} )}^{2} \qquad ( 3 )$$

where e(x)_{RGD} is the error function of the relative girder displacements (RGDs), RGD(x)ᵢ^{a} is the simulated value of the relative girder displacement (RGD) that is variable in the simulator for a finite element model, and RGDᵢ^{m} is the actually measured value of the relative girder displacement (RGD).

It is noted that a variable called the relative girder displacement (RGD) is a variable into which static characteristics have been incorporated and is a value which is obtained using ambient vibration test data. Accordingly, in the present embodiment, the error function may be defined as the variable “relative girder displacement (RGD).” At step (a) S10, a user enters the actually measured deflection displacement value δm of the girder 10. In this case, at step (b-2) S303, the actually measured relative girder displacement RGDᵢ^{m} is calculated via Equation 1 or 2 defined at step (b-1) S301.

Step (b-3) S305 refers to the step of calculating a relative girder displacement (RGD) when the error function of the relative girder displacements (RGDs) defined at step (b-2) S303 is minimized. The server in which the method of calculating a stiffness coefficient according to the present embodiment has been implemented varies RGD(x)i^{a} by simulating the finite element model, and calculates a relative girder displacement (RGD) value via the error function e(x)_{RGD} while RGD(x)i^{a} is varied. In other words, at step (b-3) S305, the simulator for a finite element model calculates a relative girder displacement (RGD) when e(x)_{RGD} is minimized while varying RGD(x)i^{a}.

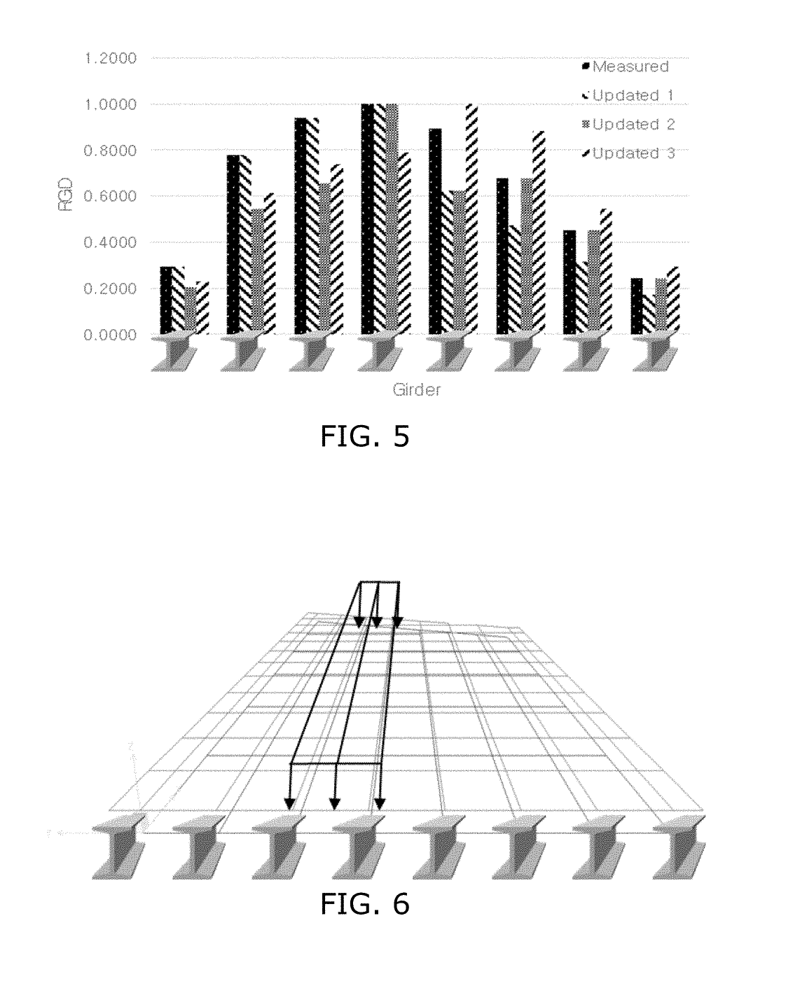

FIG. 4 shows the step of calculating the stiffness coefficient of the bridge 1 according to an embodiment of the present invention. Referring to FIG. 4, step (c) S50 may include step (c-1) S501 of defining a relative girder displacement assurance criterion (RGDAC), step (c-2) S503 of defining the error function of the bridge 1 by using the relative girder displacement assurance criterion (RGDAC), and step (c-3) S505 of calculating the stiffness coefficient k of the bridge 1.

Step (c) S50 refers to the step of calculating the stiffness coefficient k of the bridge 1 from the error function of the bridge 1 using the relative girder displacements (RGDs) as a variable by taking into account the deflection shape of the bridge 1 in the relative girder displacements (RGDs) calculated at step (b) S30.

In the above-described paper of the present applicant (Do-bin Kim and three other persons, “Improvement of Finite Element Model Using Relative Girder Displacement (RGD) and Evaluation of Rating Factor,” 2014 Regular Academic Conference of the Korean Society of Civil Engineers), the relative girder displacement (RGD) was defined in order to incorporate static characteristics into a dynamic characteristic test. However, a problem arises in that the deflection shape of the bridge 1 is not taken into account because the relative girder displacement (RGD) is defined as a proportion. FIG. 5 shows the relative girder displacements (RGDs) of various shapes having minimum error values in the error function based on Equation 3.

The values of displacements δ and relative girder displacements (RGDs) for the individual girders 10 calculated in the test example of step (b) S30 according to the present embodiment are listed in Table 1 below:

TABLE 1

| | δ_{D} (mm) | RGD_{i,max} |
|---|---|---|
| 1^{st} girdier | 1.9807 | 0.2928 |
| 2^{nd} girder | 5.1251 | 0.7768 |
| 3^{rd} girder | 6.234 | 0.9395 |
| 4^{th} girder | 6.6449 | 1 |
| 5^{th} girder | 5.8666 | 0.8913 |
| 6^{th} girder | 4.3722 | 0.6785 |
| 7^{th} girder | 2.8536 | 0.4533 |
| 8^{th} girder | 1.4787 | 0.2457 |

Table 1 shows the data values of the finite element model obtained through the performance of step (b) S30. When step (b-3) S305 is performed based on the test data of Table 1, e(x)_{RGD} is obtained as 0.045. In this case, the relative girder displacements (RGDs) in which e(x)_{RGD} satisfies 0.045 may correspond to various shapes of the girders 10, rather than one shape of the girders 10, as shown in FIG. 5.

Referring to FIG. 5, there may be the RGDs of various cases (Updated 1, 2, and 3) that are substantially different from the actually measured RGD values of the girders. The RGD values (Updated 1, 2, and 3) in which e(x)_{RGD} satisfies 0.045 in the test example of FIG. 5 are shown in Table 2 below:

TABLE 2

| | True RGD | Updated 1 | Updated 2 | Updated 3 |
|---|---|---|---|---|
| 1^{st} girdier | 0.2928 | 0.2928 | 0.205 | 0.2308 |
| 2^{nd} girder | 0.7768 | 0.7768 | 0.5438 | 0.6121 |
| 3^{rd} girder | 0.9395 | 0.9395 | 0.6576 | 0.7403 |
| 4^{th} girder | 1 | 1 | 1 | 0.788 |
| 5^{th} girder | 0.8913 | 0.6239 | 0.6239 | 1 |
| 6^{th} girder | 0.6785 | 0.475 | 0.6785 | 0.8821 |
| 7^{th} girder | 0.4533 | 0.3173 | 0.4533 | 0.544 |
| 8^{th} girder | 0.2457 | 0.172 | 0.2457 | 0.2948 |

Accordingly, according to the embodiment of the present invention, at step (c) S50, the variable “relative girder displacement assurance criterion (RGDAC)” is defined in order to enable the relative girder displacement (RGD) to take into account the shape of the bridge 1, and the stiffness coefficient of the RGD incorporating the shape of the actual bridge 1 thereinto is calculated.

Step (c-1) S501 refers to the step of defining the relative girder displacement assurance criterion (RGDAC) as the outer product of the actually measured vector of the relative girder displacement (RGD) and the simulated vector of the relative girder displacement (RGD). Step (c-1) S501 enables the deflection shape of the bridge to be taken into account by correcting the relative girder displacements (RGDs) represented by individual values. The corrected relative girder displacement is named a relative girder displacement assurance criterion, and may be abridged to “RGDAC.”

At step (c-1) S501, the RGDAC is defined as the outer product of the RGDs. When the RGD is corrected to the outer product of vectors, the RGD incorporating the actually measured shape of the bridge thereinto allows the value of the outer product of the actually measured vector of the RGD and the variable vector of the RGD to become 1. At step (c-2) S503, the error function in which a result value is minimized is defined by taking into account the fact that the RGDAC is defined as the outer product of vectors at step (c-1) S501 and the value of the RGDAC incorporating the shape of the bridge thereinto becomes 1. The error function defined at step (c-2) S503 becomes the error function of the bridge that is used to calculate the final stiffness coefficients of the girders 10.

Step (c-2) S503 refers to the step of defining the error function of the bridge by using the relative girder displacement assurance criterion (RGDAC), as shown in Equation 4 below:

e2(x)_{RGDAC}=|1−RGDAC| (4)

where RGDAC is a relative girder displacement assurance criterion, and e2(x)_{RGDAC} is the error function of the bridge.

Step (c-3) S505 refers to the step of calculating the stiffness coefficient k of the bridge by using the error function of the bridge defined at step (c-2) S503. In the present embodiment, step (c-3) S505 calculates the value of the RGDAC when e2(x)_{RGDAC} is minimized. According to the defined concept of the RGDAC, the value of the RGDAC when e2(x)_{RGDAC} is minimized becomes an RGD value that incorporates the actually measured shape of the RGD thereinto. At step (c-3) S505, a corresponding stiffness coefficient k is calculated from the value of the RGDAC when e2 (x)_{RGDAC} is minimized.

FIG. 6 shows a test example in which the stiffness coefficient of a bridge is calculated, which shows a case where an ambient vibration load is applied to some girder 10 of the bridge 1. In the test example of FIG. 6, the ambient vibration test data entered at step (a) S10 according to an W embodiment of the present invention is shown in Table 3 below:

TABLE 3

| | Measured | Baseline | | |
|---|---|---|---|---|
| Mode | frequency | frequency | Discrepancy | |
| No. | (Hz) | (Hz) | (%) | Description |
| 1 | 2.471 | 2.6448 | −7.03% | Bending (B1) |
| 2 | 3.069 | 3.4494 | −12.39% | Torsion(T1) |
| 3 | 4.829 | 6.006 | −24.37% | Lateral (L1) |
| 4 | 8.157 | 7.8064 | 4.30% | Lateral (L2) |
| 5 | 9.398 | 10.1833 | −8.36% | Torsion(T2) |
| 6 | 10.538 | 11.8343 | −12.30% | Lateral + Bending(C1) |

In the ambient vibration test case of FIG. 6, the results of calculating a stiffness coefficient according to the conventional finite element model, the results of calculating a stiffness coefficient by using the variable “RGD,” and the results of calculating a stiffness coefficient by using the variables “RGD” and “RGDAC” according to the embodiment of the present invention are summarized in Table 4 below:

TABLE 4

| | e_{NF} | e_{MAC} | e_{DISP} | e_{RGD} | e_{RGDAC} | Objective Function |
|---|---|---|---|---|---|---|
| Case 1 | • | | | • | | minJ1(x) = min(e_{NF} + |
| | | | | | | e_{RGD}) |
| Case 2 | • | | | | • | minJ2(x) = min(e_{NF} + |
| | | | | | | e_{RGDAC}) |
| Case 3 | • | | | • | • | minJ3(x) = min(e_{NF} + |
| | | | | | | e_{RGD} + e_{RGDAC}) |
| Case 4 | • | • | | | | min J4(x) = min(e_{NF} + |
| | | | | | | e_{MAC}) |
| Case 5 | • | • | • | | | min J5(x) = min(e_{NF} + |
| | | | | | | e_{MAC} + e_{DISP}) |

Cases 1 to 4 are test examples of calculating stiffness coefficients by using data in a dynamic load test. Case 5 takes into account static deflections e_{DISP}, and has the most ideal stiffness coefficient value of the bridge. In this case, case 4 is the case of calculating a stiffness coefficient by using a natural frequency e_{NF} and a conventional error function e_{MAC}, and is based on the conventional finite element model. In contrast, the method of calculating a stiffness coefficient according to the present embodiment corresponds to case 3 that incorporates RGD and RGDAC thereinto.

In the evaluation of the rating factor of the same bridge 1, one of the cases 1 to 4 in a dynamic load test that has a result value most similar to that of case 5 ideal in a static characteristic test will become the most preferred method of calculating a stiffness coefficient.

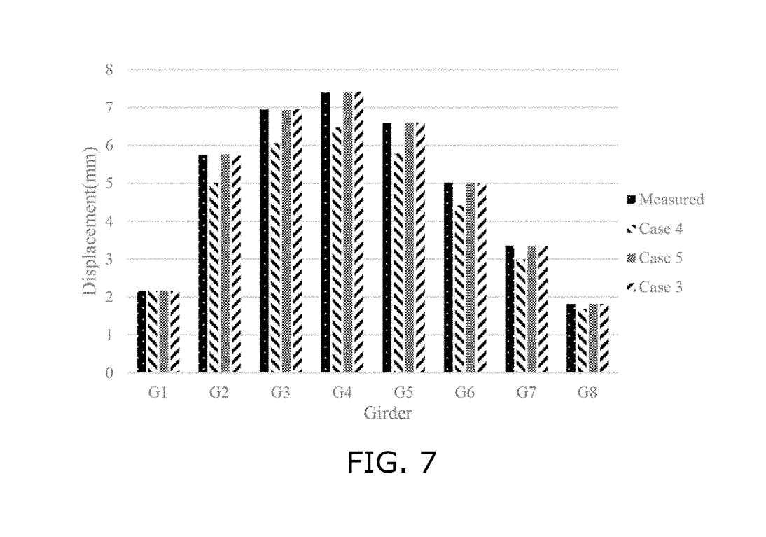

FIG. 7 is a graph showing the comparisons among the deflection displacements of girders actually measured as the results of the test examples of FIG. 6, the deflection displacements of girders obtained using the conventional method, and the deflection displacements of girders obtained using the method of calculating a stiffness coefficient according to the present embodiment.

Referring to FIG. 7, ideal case 5 shows the displacements of the girders 10 that exactly coincide with the actually measured displacements of the girders. Furthermore, case 3 incorporating RGD and RGDAC thereinto by means of the method of calculating a stiffness coefficient according to the present embodiment shows the actually measured displacements of the girders and the displacements of the girders 10 that coincide with those of case 5. It is noted that it can be seen that a considerable error occurred because case 4 according to the conventional finite element model exhibited an accurate displacement value for a No. 1 model girder but exhibited displacements lower than actually measured values for girders G2 to G8.

As another embodiment of the present invention, there is provided a computer-readable storage medium having stored therein a program for calculating the stiffness coefficient of a bridge by using a finite element model that, when executed by a computer, causes the computer to perform: step (a) S10 of receiving the information of a bridge in an ambient vibration test via a simulator for a finite element model; step (b) S30 of calculating relative girder displacements (RGDs) by converting the deflection displacements of the bridge into proportions; and step (c) S50 of calculating the stiffness coefficient k of the bridge from the error function of the bridge using the relative girder displacements (RGDs) as a variable by taking into account the deflection shape of the bridge in the relative girder displacements (RGDs) calculated at step (b) S30.

As a preferred embodiment, the method of calculating the stiffness coefficient of a bridge shown in FIGS. 1 to 4 may be embedded in the form of a program, and may be provided to calculate the stiffness coefficient of a bridge via a webpage. Via a computer-readable storage medium having a program stored therein, steps (a) S10 to (c) S50 may be performed using a server or downloadable data. A simulator for a finite element model may be embedded in the server, and a webpage on which a plurality of users can enter the actually measured test data of a bridge may be constructed via the server.

According to the present invention, the deflection displacements of a bridge are converted into proportions and the error function of the bridge is defined using relative girder displacements as a variable, and thus even ambient vibration data may incorporate static characteristics thereinto.

In greater detail, according to the present invention, by taking into account the fact that the cases of the actual deflection displacements (scalar values) of girders satisfying a stiffness coefficient calculated based on relative girder displacements defined as proportions are various, a relative girder displacement assurance criterion (RGDAC) is obtained by obtaining the outer product of the vector of the relative girder displacement value simulated such that the shapes of girders can be similar to actually measured shapes and the vector of the actually measured relative girder displacement value, and the error function of the bridge is defined based on the relative girder displacement assurance criterion (RGDAC). Accordingly, the finite element model improved according to the present invention may take into account both static characteristics and dynamic characteristics, and a stiffness coefficient in which the shape of the bridge is taken into account may be calculated.

Although the present invention has been described in detail above via the representative embodiments, it will be apparent to those having ordinary knowledge in the art to which the present invention pertains that various modifications may be made to the above-described embodiments without departing from the scope of the present invention. Therefore, the scope of the present invention should not be defined only based on the described embodiments, but should be defined not only based on the attached claims but also based on all modifications or alterations derived from the equivalent concepts of the attached claims.

What is claimed is:

1. A method of calculating a stiffness coefficient of a bridge by using a finite element model, the method comprising:
step (a) of receiving information of a bridge in an ambient vibration test via a simulator for a finite element model;
step (b) of calculating relative girder displacements (RGDs) by converting deflection displacements of the bridge into proportions; and
step (c) of calculating a stiffness coefficient k of the bridge from an error function of the bridge using the relative girder displacements (RGDs) as a variable by taking into account a deflection shape of the bridge in the relative girder displacements (RGDs) calculated at step (b);
wherein the relative girder displacement (RGD) is defined as a value obtained by dividing a displacement value generated in each of girders by a displacement value of a girder having a largest one of displacement values generated in the respective girders of the bridge in an ambient vibration test, and the stiffness coefficient k of the bridge is calculated using ambient vibration test data.

2. The method of claim 1, wherein step (a) comprises receiving data on displacements generated by the girders of the bridge during ambient vibration as the information of the bridge via the simulator for a finite element model.

3. The method of claim 1, wherein each of the relative girder displacements (RGDs) at step (b) is defined by Equation 1 below:
$${RGD}_{i} = \frac{{δ}_{i}}{max ( {δ}_{i} )} \qquad ( 1 )$$
where RGD is the relative girder displacement, δ is the displacement value, i is a grid number of the each of the girder, and max(δ) is the displacement value of the girder having the largest one of the generated displacements.

4. The method of claim 1, wherein step (b) enables calculation of the stiffness coefficient independent of a magnitude of the load applied to the bridge in such a manner that the relative girder displacements (RGDs) convert the deflection displacements of the individual girders of the bridge into proportions.

5. The method of claim 1, wherein step (b) comprises:
step (b-1) of defining the relative girder displacements (RGDs);
step (b-2) of defining the error function of the relative girder displacements (RGDs) each obtained by dividing a difference between a simulated value of the relative girder displacement (RGD) and an actually measured value of the relative girder displacement (RGD) by the actually measured value of the relative girder displacement (RGD); and
step (b-3) of calculating the relative girder displacements (RGDs) when the error function of the relative girder displacements (RGDs) defined at step (b-2) is minimized.

6. The method of claim 5, wherein the error function of the relative girder displacements (RGDs) at step (b-2) is defined by Equation 3 below:
$${e ( x )}_{RGD} = \frac{1}{M} {\sum }_{i = 1}^{M} {( \frac{{RGD ( x )}_{i}^{a} - {RGD}_{i}^{m}}{{RGD}_{i}^{m}} )}^{2} \qquad ( 3 )$$
where e(x)_{RGD} is the error function of the relative girder displacements (RGDs), RGD(x)ᵢ^{a} is the simulated value of the relative girder displacement (RGD) that is variable in the simulator for a finite element model, and RGDᵢ^{m} is the actually measured value of the relative girder displacement (RGD).

7. The method of claim 1, wherein:
step (c) comprises step (c-1) of defining a relative girder displacement assurance criterion (RGDAC) as an outer product of an actually measured vector of the relative girder displacement (RGD) and a simulated vector of the relative girder displacement (RGD); and
a deflection shape of the bridge is taken into account by correcting the relative girder displacements (RGDs) represented by individual values.

8. The method of claim 7, wherein:
step (c) comprises step (c-2) of defining the error function of the bridge by using the relative girder displacement assurance criterion (RGDAC), as shown in Equation 4 below:
e2(x)_{RGDAC}=|1−RGDAC| (4)
where RGDAC is a relative girder displacement assurance criterion, and e2(x)_{RGDAC} is the error function of the bridge; and
the stiffness coefficient k is calculated based on the relative girder displacement assurance criterion (RGDAC) when the error function of the bridge is minimized.

9. A computer-readable storage medium having stored therein a program for calculating a stiffness coefficient of a bridge by using a finite element model that, when executed by a computer, causes the computer to perform:
step (a) of receiving information of a bridge in an ambient vibration test via a simulator for a finite element model;
step (b) of calculating relative girder displacements (RGDs) by converting deflection displacements of the bridge into proportions; and
step (c) of calculating a stiffness coefficient k of the bridge from an error function of the bridge using the relative girder displacements (RGDs) as a variable by taking into account a deflection shape of the bridge in the relative girder displacements (RGDs) calculated at step (b).
